(19) United States
(12) Patent Application Publication
(10) Pub. No.: US 2005/0055725 A1
(43) Pub. Date: Mar. 10, 2005

(54) Interactive audio/video system

(76) Inventor: Christopher Stewart, Tamarac, FL (US)

Correspondence Address: THE DIRECTV GROUP INC, PATENT DOCKET ADMINISTRATION RE/R11/A109, P O BOX 956, EL SEGUNDO, CA, 90245-0956, US

(21) Appl. No.: 10/765,491

(22) Filed: Jan. 26, 2004

Related U.S. Application Data
(60) Provisional application No. 60/501,501, filed on Sep. 9, 2003.
(60) Provisional application No. 60/503,941, filed on Sep. 18, 2003.

(51) Int. Cl. H04N 7/173; H04N 7/18

(52) U.S. Cl. 725/92; 725/14; 725/75

(57) ABSTRACT

The present invention relates to an interactive entertainment system and method comprising: a system server (110), said system server (110) residing at a communication center (100); a system database (120), said system database (120) residing at the communication center (100) and accessible by the system server (110); a plurality of entertainment files stored on the database (120), where the system server (110) retrieves the plurality of entertainment files for transmission over a first communication network; a reception device (30), where the reception device (30) includes an integrated receiver decoder (IRD), where the IRD selectively retrieves the plurality of entertainment files via the first communication network from the system server based a user's preferences; a user input device (35), where said user input device (35) enables a user to interact with the system server (110) and system database (120) via the reception device (30), where the user provides real time feedback regarding said entertainment files; and a user output device (34), where said output device (34) plays selected entertainment files.

### CROSS REFERENCE TO RELATED APPLICATIONS

The present application claims priority to provisional U.S. patent application Ser. No. 60/501,501, filed Sep. 9, 2003 (entitled “Artificial Intelligence Listening System”), and provisional U.S. patent application Ser. No. 60/503,941, filed Sep. 9, 2003 (entitled “Artificial Intelligence Video System”). Each of these co-pending applications is assigned to the assignee of the present disclosure and incorporated herein by reference.

### BACKGROUND OF THE INVENTION

1. Field of the Invention

The present invention relates to an interactive audio/video system.

2. Description of Related Art

Many consumers enjoy various forms of entertainment that may be broadcasted through the airwaves, recorded on media for replay and/or transmitted through vast computer networks. The forms of entertainment include movies, television shows, music, music videos, game shows, talk shows, games, chat rooms, live web cams and video clips. The various forms of entertainment are either transmitted for real time replay or stored on mediums such as compact discs CD's or digital versatile discs DVD's. Other forms of replay include the transmission of compressed files for replay in a MP-3 format or the streaming of audio/video files over the communication networks.

Although many modes, forms and mediums exist for the replay of entertainment, technology fueled the evolution replay options. Music aficionados, for example, enjoy recorded music in many forms and mediums. The earliest mediums involved records on cylinders of wax and thin foil that later evolved to disc records. Disc records were the primary medium of recording and playback for many years. Magnetic tape, i.e., reel to reel, cassette and 8 track, emerged in the 1960's and 70's and offered an alternative to disc records. By the 1980's audio cassettes began to dominate as the preferred medium of sound recordings. The popularity of the cassette tape was energized by various portable electronic players that enabled more flexible uses of the cassettes, such as boom boxes, Sony walkmans, car cassette players, etc. Along with the evolution of the medium formats, the mode of playback also evolved. Initially, sound recordings were recorded and played back in mono, but the development of the long playing (LP) records, a.k.a., the “33”, enabled the production of high fidelity stereo replay for music listeners. Noise reduction techniques, i.e., Dolby NR, improved the listening capabilities for cassette tapes. As one may ascertain, the advances associated with the recording medium and the consumer electronics have constantly produced a synergy for the creation of higher quality and more user friendly means for music listening. The synergy of the electronics and recording medium has continued to constantly grow and evolve over the last twenty years.

By the late 1980s, digital recording and playback was introduced to music listeners. New modes of sound recording storage emerged such compact discs and digital audio tape. Compact discs, however, clearly became the preferred choice for digital sound recordings and soon created a complete revolution in the music reproduction industry. Musicians now record songs and creations digitally for playback on compact disc players. Compact discs provide one of the highest levels of music listening available for the consumer. Electronic manufacturers have produced appropriate components, i.e., portable CD players, CD/RW players, multiple disc players, in dash CD players, etc., to further fuel the dominance of compact discs as the primary music medium of the 90's and the new millennium.

Technology and recording mediums continue to grow and consequently further methods of music delivery have emerged. Although, compact discs have grown to dominate the music reproduction industry, the Internet and cable television have also expanded in terms of use, quality and functionality in relation to delivery of music. As personal computers grew in popularity in the 1990s, manufacturers added various features to broaden the interests in PCs in order to make them an appealing consumer product. Initially, PCs were used primarily for word processing, business statistical analysis and gaming. However, as the faster graphics, higher quality sound cards and overall user friendliness evolved, the PCs expanded to a communication and information vehicle. The key peripheral aspect of PCs that ignited and fuel the explosive growth of the personal computer was the Internet. PCs gave consumers the capabilities to connect to a worldwide web and, thus, access various forms of information, communications and entertainment. A certain degree of synergy essentially merged between the development of the Internet and the PC. Methods of accessibility to the Internet increased as did the personal computer hardware and software evolved to allow users access to various functionalities that programmers developed to attract more and more consumers to the Internet.

The Internet initially presented pages to the user for informational purposes, however, entrepreneurs soon recognized the entertainment capabilities of the Internet. In particular, PC users are able to listen to music being streamed over the Internet to speakers connected to their desktop or laptop computers. Accordingly, yet another medium has emerged for music listening, streaming music via the Internet. Cable and satellite TV systems also provide music streaming channels where users may listen to various types of music being streamed over the music channels. Streaming music enables music listeners to hear a continuous stream of songs associated with a plethora of music genres. A conventional streaming format allows a user to select a particular music genre from a list provided by a streaming media provider (SMP). The SMP allows the user to connect to the music stream as desired by the user. The user then enjoys an endless stream of songs for their listening pleasure. The major advantages of music streaming include the endless stream of commercial-free music listening and the ability for the users to chose their desired music genre.

In regard to the world of visual entertainment, initially moving pictures supplied consumers with one of their first forms of visual entertainment which has now transformed into a cornucopia audio/visual mediums and transmission options. The first moving pictures lacked any audio content and provided strictly moving pictures. As motion picture technology evolved first audio and then color was added as additional components of the motion picture. For many years motion pictures were viewed at theaters and as such audio/visual entertainment was limited to about two hours of viewing to a somewhat limited audience. Although films were distributed to a number of theatres, the audience was limited due to seating capacities and the number of theatre locations.

The ability to provide audio/visual entertainment expanded greatly with the television broadcasting. Television broadcasting enabled producers to reach a vastly greater audience simultaneously. Earlier television broadcasts involved the transmission of audio/visual signals via the airwaves through frequencies designated by the FCC. Initial broadcasts use VHF carrier frequencies, however over time UHF provided alternative frequencies for television broadcasts. Television created a phenomenal surge in audio visual entertainment even as early as 1948 about one million homes in the U.S. had a television set. Similar to moving pictures, initial television broadcasts were in black and white, by the 1960's television broadcasts were in color and in 1968, 78 million television sets were in use in the U.S. and 200 million worldwide. Also in the late 1960's, the FCC authorized pay TV stations (cable).

By the late 1960's, two forms of audio visual entertainment were firmly entrenched in the popular culture, motion pictures and television. These two industries began to overlap as television stations began broadcasting motion pictures that had completed their run in theatres. Furthermore, video cassette tapes emerged as viable consumer medium for home viewing of motion pictures and enabled consumers to view movies and programs on their televisions. Video cassette players with recording capabilities, i.e. the VCR, were later developed that gave consumers some form of control over their viewing preferences.

During the 1980's cable television increased in popularity and the FCC granted permits for direct broadcast satellite TV systems. Now consumers could receive audio visual entertainment in the form of motion pictures, television broadcast cable TV broadcast, satellite TV broadcast and video cassette tapes. The implementation of digital storage and transmission capabilities further expanded the audio visual options for consumers. Presently, owners may record or view motion pictures and/or television programming on DVD's, through cable TV providers, satellite broadcasts or conventional television broadcasts. Consumers may also view video streaming via an internet connection as provided by SMP's. Many SMP's provide various forms of audio visual files over broadband connections.

The various mediums and transmission outlets enable consumers to have an enormous number of choices in terms of viewing and listening, however the ability for real time consumer feedback is essentially non-existent. Consumers may receive various broadcasts and purchase showings for replay but the ability for immediate feedback is generally not available.

The present formats of music and video streaming lack the capability to enable user input into the streaming process. Although many users may narrow their listening or viewing choices to a limited number of choices, the SMP determines what media are placed into the stream. It would be advantageous to provide user interaction with the SMP in order to provide media streaming uniquely designed to suit a user's taste. Shortcomings particular to internet SMP's include a multitude of advertising, i.e., pop ups, advertising banners that may be transmitted to the user's PC while connected to the SMP. Also, many internet SMP's require a broadband internet connection in order to effectively use the service. Even users who have a broadband connection to the Internet might be subject to drops from the SMP due to internet congestion. Cable and satellite TV music streaming generally do not have the same type of problems as internet SMP's. Cable and satellite TV SMP's however do not offer unique user streaming based upon the user's taste. Accordingly, in order to further expand the growth of entertainment options available for consumers, it would be advantageous to provide unique user media streaming based upon user preferences as supplied by the user.

### SUMMARY OF THE INVENTION

The present invention relates to an interactive entertainment system that allows users to listen to streams of entertainment files based upon user preferences. The entertainment files may include audio or audio/video content from a wide variety of genres and may be categorized in appropriate genres for streaming purposes. Users retrieve the entertainment files that are streamed upon a first communications system such as cable or satellite television broadcasts. Upon user execution, a user reception device retrieves an entertainment file for playback. The user reception device determines if the current playing entertainment file has an acceptable user rating for complete playback. If the rating is acceptable, then the user reception device plays the current entertainment file to completion. If the rating is unacceptable, then the user reception device reviews the rating of entertainment files playing on other streams, finds a higher rated entertainment file and substitutes it for the current entertainment file. If the user reception device fails to find a higher rated entertainment file, then it allows the completion of the current entertainment file. The entertainment files of the present invention are rated by each individual user and the unique user ratings determine the playback by the user reception device. Each user may submit entertainment file ratings during playback or immediately following playback.

It is therefore an object of the present invention to provide an interactive entertainment system comprising: a system server, said system server residing at a communication center; a system database, said system database residing at the communication center and accessible by the system server; and a plurality of entertainment files stored on the database, where the system server retrieves the plurality of entertainment files for transmission over a first communication network. A reception device, where the reception device includes an integrated receiver decoder (IRD), selectively retrieves the plurality of entertainment files via the first communication network from the system server based on a user's preferences. A user input device enables a user to interact with the system server and system database via the reception device, where the user provides real time feedback regarding said entertainment files. A user output device plays the selected entertainment files.

In accordance with these and other objects which will become apparent hereinafter, the instant invention will now be described with particular reference to the accompanying drawings.

### BRIEF DESCRIPTION OF THE DRAWINGS

FIG. 1 shows an exemplary music entertainment system according to the present invention.

FIG. 2 shows another exemplary music entertainment system according to the present invention.

FIG. 3A shows an exemplary schematic diagram according to the present invention.

FIG. 3B shows another exemplary schematic diagram according to the present invention.

FIG. 4 shows an exemplary video entertainment system according to the present invention.

FIG. 5 shows an exemplary video entertainment system according to the present invention.

### DETAILED DESCRIPTION

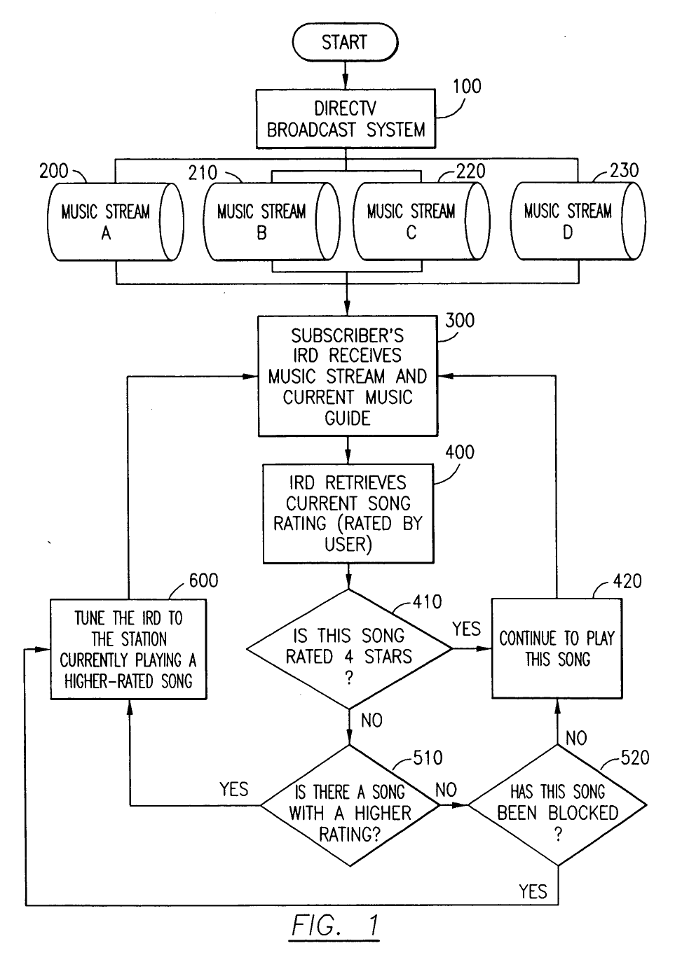

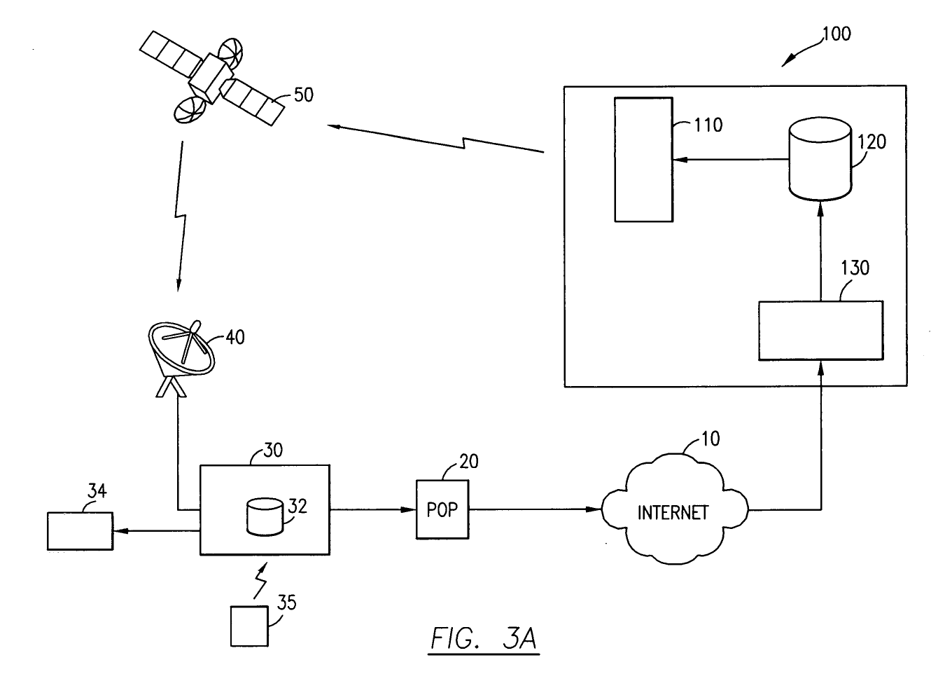

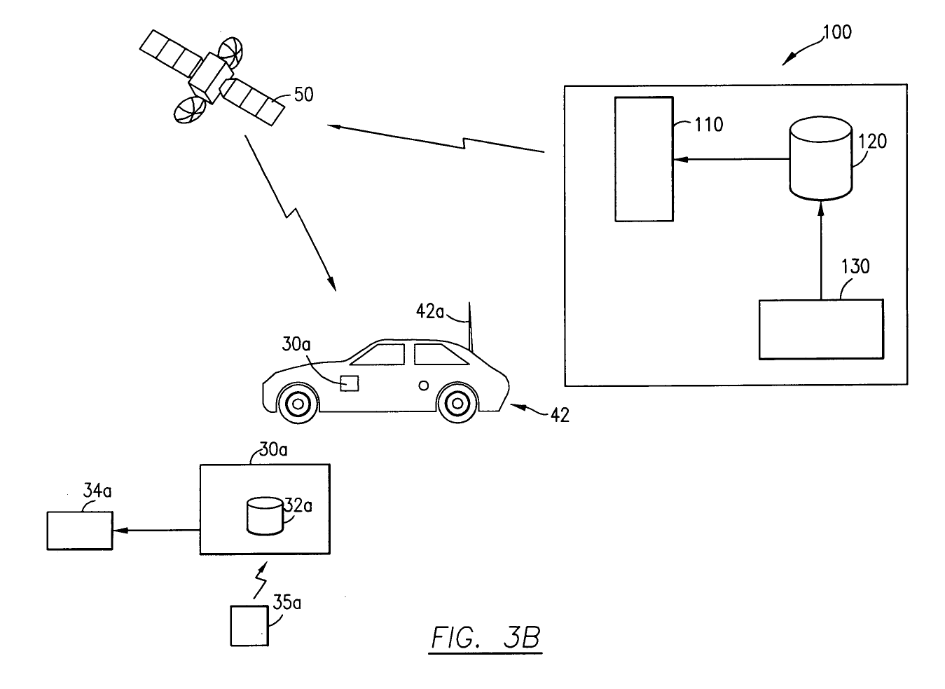

Referring to FIG. 1 an exemplary overview of the present invention is shown. A satellite TV system 100 broadcasts multiple streams of music over its system. The satellite TV system 100 provides a central hub or server 110, shown in FIG. 3A, for streaming a plurality of audio files, shown in FIG. 1 as Music Stream A, Music Stream B, Music Stream C and Music Stream D. The audio files contain various music genres that are provided on channels broadcasted over the satellite TV system 100. Users may select a particular music genre based upon their desired taste by using a user input device 35 and user reception device 30, FIG. 3A. Upon selection of a particular music genre, the satellite TV system 100 allows a user to listen to a stream of music. Each user has a user reception device such as an integrated receiver decoder (IRD) 30, see FIG. 3A, which retrieves the music stream based upon a user's selection. The IRD 30 provides the users with access to the satellite TV system 100. The user's IRD 30 receives the music streams based upon the current music streaming guide 300. The IRD 30 retrieves the current song rating 400 as previously rated by the individual user. The IRD 30 advantageously determines whether the current song has an acceptable rating to continue play 410. If the current song has an acceptable rating, the song continues to play 420 until complete, and then the IRD 30 receives the next song selection of the music stream. Should the current song not have an acceptable rating, the IRD 30 selectively retrieves ratings of songs currently playing and ranks the songs based upon the ratings previously provided by the user 600. If any other songs playing have a higher rating than the current song 510, then the IRD 30 immediately tunes to the appropriate music stream associated with the higher rated song 600. If the other songs playing do not have a higher rating than the current song, then the IRD 30 also determines whether the current song playing has been blocked by the user 520, if not, the IRD 30 continues to play the song to completion. However, if the user has blocked the play of this particular song, the IRD 30 tunes to the next highest rated song on the ranking list 600.

FIG. 3A shows an overview of a schematic of the data flow according to the present invention. The plurality of audio files are transmitted from server 110 to a satellite 50 and relayed to an antenna 40. The IRD 30 retrieves the audio files for play back on a user output device such as a stereo system or television. The audio files may include data such as the artist, individual title, collection title and year of release. The audio files may also be coupled to video files and enable the user to view a music video.

Although not shown, if an unrated song plays, the user via the user input device 35 may submit a rating for the song at any time during or immediately after the song completes play. Furthermore even if a song has been rated, then the user may submit an updated rating. In either case, the IRD 30 receives the rating from the user and temporarily stores the rating on a user database 32. The IRD 30 associates the rating with the identifying title for the song. Periodically, the IRD 30 transmits the user's rating back to the satellite TV system's 100. In one exemplary embodiment, the ratings from the user are transmitted via a second communications network such as the internet 10, alternatively the IRD 30 may enable two-way communication over the first communications network. The IRD 30 may be connected to the internet 10 via a point of presence (POP) 20. A transaction server 130 retrieves the user ratings and transmits the data for storage on system database 120. The system 100 stores the user's rating information for retrieval during subsequent streaming. The rating system provides for an interactive and intelligent means for entertainment to the music streams delivered by the satellite system.

In an exemplary embodiment, the user may select music stream B 210, which may be associated with the current hip hop song selections. The music stream B may be currently playing song 1 which has a rating of three stars associated with it. Upon detection of the three star rating, the IRD 30 simply allows the continued play of song 1; however, the IRD 30 begins searching the other music streams in order to find songs currently playing which are preferably above the three star level, i.e., four star songs. If no other songs are playing that are above the three star level, then the IRD 30 checks to see if the current song has been blocked by the user, if not, the IRD 30 allows the continued play of song 1. If higher rated songs exist along the other music streams such as music stream D 230, then the IRD 30 tunes to that particular music stream currently playing a higher rated song and then the IRD 30 receives the music stream for that particular song.

An exemplary rating system may include user ratings for both particular songs and particular artists. In order to facilitate input capabilities compatible with a conventional input device, i.e., remote control, numerical values 0-4 may be used for song ratings and 5-9 for artists ratings. The Table 1 below shows how the numerical values would be associated with the ratings.

TABLE 1

| Song Rating | Artist Ratings |
|---|---|
| 0 = Do Not Play Song/Block Song | 5 = Do Not Play Artist/Block Artist |
| 1 = 1 Star | 6 = 1 Stars |
| 2 = 2 Stars | 7 = 2 Stars |
| 3 = 3 Stars | 8 = 3 Stars |
| 4 = 4 Stars | 9 = 4 Stars |

The numerical values associated with the ratings could be easily stored and retrieved during the streaming process.

The above example as associated with FIG. 1 describes a seeking system for the present invention. Under the seeking system, the IRD 30 selectively screens songs playing in the music streams and ensures that the user receives acceptable songs for their entertainment pleasure. The IRD 30 actively seeks out acceptable songs by reviewing current songs being played on each music stream, individually ranking these songs based upon their ratings, and then, providing the user with a song that meets the user's criteria.

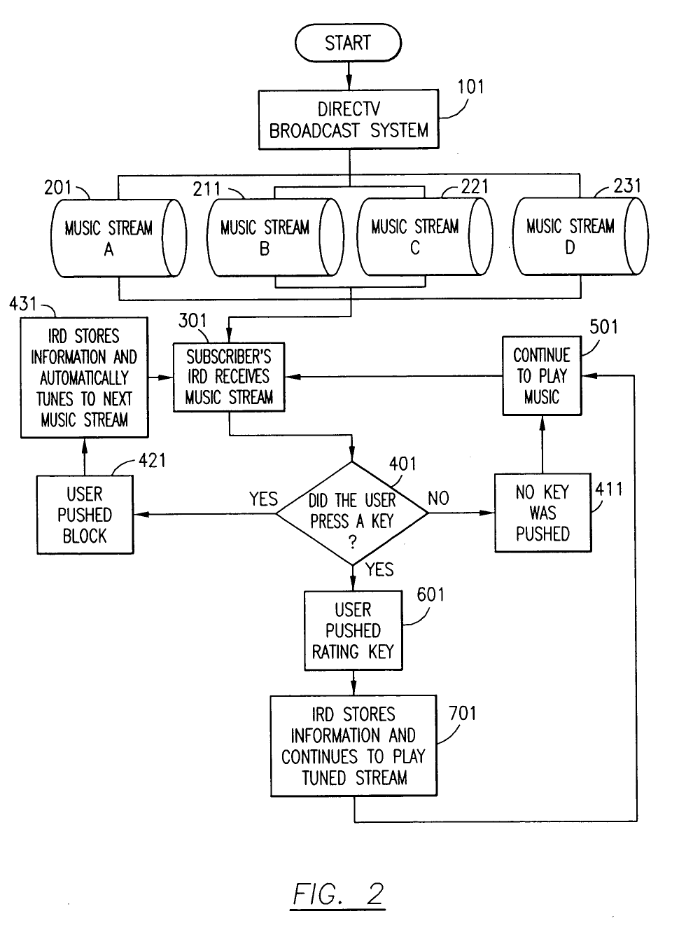

Another exemplary system to use in conjunction with the music streaming system of the present invention includes a method for the user to actively select or de-select a particular song playing upon a music stream. As shown in FIG. 2, the IRD 30 receives a music stream at 301, the user then may either make a rating selection or elect not to make any type of rating selection at all 401. If the user does not select any rating 411, i.e., rating key not pushed, then the song continues to play 501. If the user selects a rating for the song 601, the IRD 30 stores the rating and continues to play the current song 701. The user may also select to block the song 421 which is also stored by the IRD 30 but upon the selection of song block, the IRD 30 automatically tunes to another music stream 431 and receives the current playing song from the next selected music stream. The IRD 30 may be programmed to select music streams sequentially or randomly based upon the user's preference. Furthermore, the IRD 30 may be limited to a subset of music streams as selected by the user, for example, A through G music streams are available through the broadcast system, however user only listens to music streams B, C, F and E.

Referring now to FIG. 3A, an overview of the system components according to the present invention is shown. The system 100 includes at least a server 110, a system database 120 and a transaction server 130. The system server 110 transmits signals to a satellite 50 that relays the signals to a satellite dish 40. A user reception device, IRD 30, includes a user database 32. As described above the IRD 30 executes most of the functionality associated with the transfer of files and signals. A user input device 35 controls the IRD 30 and enables the user to initiate contact with the system 100. The IRD 30 outputs the music streams to a user output device 34. The user input device 35 also provides the user with a means to submit ratings as discussed above. The user may submit ratings through two way communications with the system 100 via the satellite 50 and dish 40. Alternatively, the ratings may be transmitted via the internet 10 to a transaction server 130 for storage on the system database 120. Software residing on the user database and a processor, where neither the software nor processor is shown, enables the functionality of the IRD 30 associated with the IRD 30. Instructions provided by the software to the processor control the flow of files, signals and data through IRD 30.

FIG. 3B shows an alternative schematic overview of the present invention. Similar to FIG. 3A, a plurality of audio files may be transmitted from the server 100 to a mobile antenna 42a via satellite 50. The exemplary embodiment of FIG. 3B enables the transfer of files to an end user who may be in motion. A vehicle 42 includes a user reception device IRD 30a which retrieves the audio files for play back on user output device 34a. A user database 32a stores nay user ratings that may be submitted by the user. The user may input user ratings via the user input device 35a which are stored on user database 32a. The user ratings may be submitted to the system 100 via two way communications between antenna 42a and system 100 through satellite 50. Furthermore, RD 30a includes software and processor, not shown, to enable the functionality and transfer of data, signals and files.

Although the embodiment of FIG. 3B is shown in a vehicle 42, the IRD 30a may be transported by other portable mediums such as on a motorcycle, bicycle, moped, ship, boat, airplane or even in a personal handheld version. The IRD 30a may also be transportable between housing units where the IRD 30a may be used in multiple housing platforms for the various portable mediums. The embodiment of FIG. 3B provides users with various use capabilities; however it functions substantially similar to the stationary embodiment of FIG. 3A.

Both FIGS. 1 and 2 depict music streams A-D, however the present invention contemplates a plurality of music streams available for music listeners. Several music streaming genres may be streamed via the broadcast system 100, 101. Exemplary streaming genres include: jazz, hip hop, soul, neo-soul, R&B, rock, soft rock, heavy metal, country, classical, folk blues, etc.

Whether working under the seeking or blocking protocols, the IRD 30 provides users with an active tool and system for music listening via the satellite broadcast system. The IRD 30 operates at a high level automation within the seeking system. In contrast, the blocking system enables users to quickly eliminate an undesired song from a music stream and thus avoid any further replay of a song in the future. The IRD 30 provides a more flexible, user friendly and interactive means of listening to music.

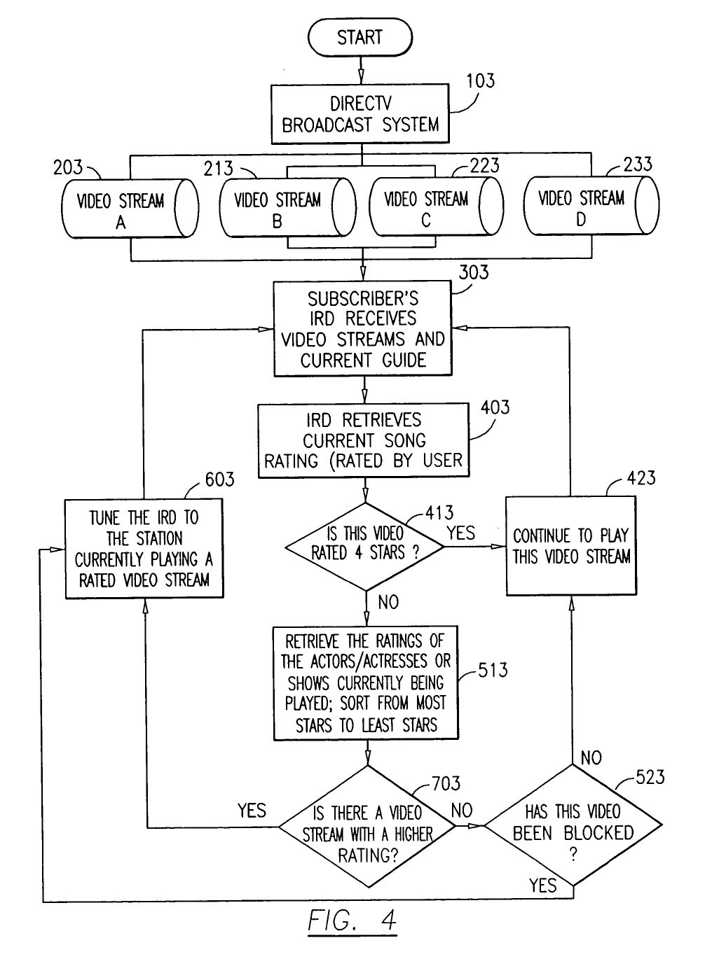

FIG. 4 shows an exemplary embodiment of the present invention involving the streaming of video content. Similarly, to the supply of audio content as described above, subscribers may receive streams of video content, video streams A-D, 203, 213, 223, 233. The IRD 30 receives the video streams 303 and retrieves a current video rating 403. A determination is made as to whether the video has an acceptable rating 413. If so the video stream continues to play; if not the IRD 30 retrieves ratings of video streams currently being played that have acceptable ratings associated with them 513. The IRD 30 then compares the video streams currently playing with the video stream being viewed by they user to determine if any contain a higher rating 703. If a higher rated video stream does not exist, then the IRD 30 ensures that the current video stream has not been blocked 523 and the video continues to play 423. If the video stream has been blocked then the IRD 30 plays another video that has been rated by the user 603.

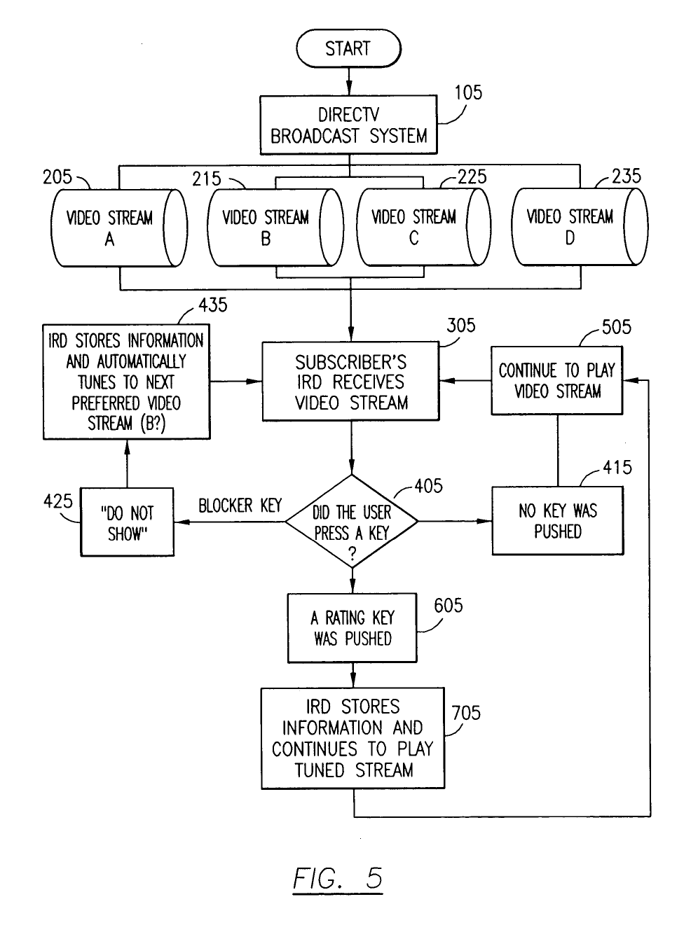

FIG. 5 shows another exemplary embodiment of the present invention related to video streaming. The system and method of FIG. 5 enables the user to rate the video streams and to block any undesired video streams. The user receives the current video stream via IRD 30 at 305. Anytime during the review of the video stream the user may elect to enter a rating through the input device 35. If the user elects not to input a rating 415, then the video stream continues to play 505. If the user inputs a rating for storage 605, then the IRD 30 stores the rating and continues to play the video stream 705. The user may also elect to block a video stream 425 and the IRD 30 stores this selection and automatically tunes to the next preferred video stream 435.

The above rating system is contemplated for use based upon individual user taste. The above rating system may also be implemented in the form of a parental control that allows parents to block certain video streams. Each user may therefore develop an individualized parental control feature that enables parents to block selected video streams that contain undesirable content. Although some broadcast systems provide standardized ratings and blocking techniques based thereupon, the present invention allows users to create individualized parental controls based upon the individual users' guide lines. The parental control of the present invention enables parents to block any video stream, although the video stream may have received an acceptable rating based upon industry standards, i.e. “G” rated material, parents may still find the content unacceptable based upon their individual standards. In order to block any video stream and thus implement customized parental control, the parental control feature is implemented through the use of rating steps associated with FIG. 5. As stated above, anytime during the review of the video stream the user may elect to enter a rating, in this case a parental rating, through the input device 35. Under the parental control feature, the user inputs a parental rating for storage at 605, and then the IRD 30 stores the parental rating and continues to play the video stream 705. If the parent elects to immediately block a video stream, video stream block 425, then the IRD 30 stores this selection and automatically tunes to the next preferred video stream 435. Once a parent blocks a particular video stream then the video stream will remain permanently blocked. By using this customized parental control, a parent may block content that may have been viewable based upon the industry rating guidelines, i.e., G, PG, PG-14, MA etc. The parental control feature as described may also be incorporated in association with the audio files as discussed with the flow chart of FIG. 2.

The instant invention has been shown and described herein in what is considered to be the most practical and preferred embodiment. It is recognized, however, that departures may be made therefrom within the scope of the invention and that obvious modifications will occur to a person skilled in the art.

1. An interactive entertainment system comprising:
a system server, said system server residing at a communication center;
a system database, said system database residing at the communication center and accessible by the system server;
a plurality of entertainment files stored on the database, where the system server retrieves the plurality of entertainment files for transmission over a first communication network;
a receiver, where the receiver selectively retrieves the plurality of entertainment files via the first communication network from the system server based on a user's preferences;
a user input device, where said user input device enables a user to interact with the system server and system database via the receiver, where the user provides real time feedback regarding said entertainment files; and
a user output device, where said output device plays selected entertainment files.

2. The interactive entertainment system according to claim 1, where said plurality of entertainment files contain audio content.

3. The interactive entertainment system according to claim 1, where said plurality of entertainment files contain video content.

4. The interactive entertainment system according to claim 1, where said plurality of entertainment files contain both video and audio content.

5. The interactive entertainment system according to claim 2, where said audio content includes songs.

6. The interactive entertainment system according to claim 5, where said songs include a plurality of music genres.

7. The interactive entertainment system according to claim 6, where said plurality of music genres are categorized and streamed for listening through the user output device.

8. The interactive entertainment system according to claim 4, where said video and audio content includes televised programming.

9. The interactive entertainment system according to claim 1, where said reception device provides two way communications between the user and the system server via the first communication network.

10. The interactive entertainment system according to claim 1, where said real time feedback is transmitted to the communication center via a second communication network.

11. The interactive entertainment system according to claim 1, where the first communication network is a satellite broadcasting system.

12. The interactive entertainment system according to claim 10, where the second communication network is an internet connection.

13. The interactive entertainment system according to claim 1, where said reception device includes a user database.

14. A method of interactive entertainment comprising the steps of:
a. streaming a plurality of entertainment files over a communications network;
b. retrieving a current play entertainment file from the plurality of entertainment files;
c. retrieving a user rating associated with the current play entertainment file;
d. if the user rating is not equal to a predetermined value, then performing the following steps f-h;
e. if the user rating is equal to a predetermined value, then go to step l:
f. retrieving user ratings associated with other entertainment files within the plurality of entertainment files;
g. comparing the user ratings associated with the other entertainment files with the user rating for the current play entertainment file;
h. if any other entertainment files have a rating higher than the rating of the current play entertainment file, then performing the steps j-m
i. if the higher rated entertainment has a user block designation, then go to step l;
j. retrieving the higher rated entertainment file;
k. substituting the higher rated entertainment file for the current play entertainment file;
l. transmitting the current play entertainment file until complete; and
m. repeating steps a-e until a user executes a termination command.

15. The method of interactive entertainment according to claim 14, further comprising the step of:
a. supplying audio content with each of the entertainment files.

16. The method of interactive entertainment according to claim 14, further comprising the step of:
a. supplying audio and video content with each of the entertainment files.

17. The method of interactive entertainment according to claim 14, further comprising the step of:
a. supplying video content with each of the entertainment files.

18. The method of interactive entertainment according to claim 15, where said audio content includes songs.

19. The method of interactive entertainment according to claim 18, where said songs include a plurality of music genres.

20. The method of interactive entertainment according to claim 19, further comprising the step of:
a. categorizing the plurality of music genres.

21. The method of interactive entertainment according to claim 16, where said audio and video content includes televised programming.

22. A method of interactive entertainment comprising the steps of:
a. streaming a plurality of entertainment files over a communications network;
b. retrieving a current play entertainment file from the plurality of entertainment files;
c. if a user inputs a recognized rating, then performing steps f-h;
d. if a user inputs a rejection rating, then performing steps i-l;
e. if a user does not input any rating, then go to step k;
f. storing the recognized rating;
g. transmitting the current play entertainment file until complete; and
h. repeating step b until a user executes a termination command.
i. retrieving a next entertainment file;
j. substituting the next entertainment file for the current play entertainment file;
k. transmitting the current play entertainment file until complete; and
l. repeating steps a-e until a user executes a termination command.

23. The method of interactive entertainment according to claim 22, where said plurality of entertainment files contain audio content.

24. The method of interactive entertainment according to claim 22, where said plurality of entertainment files contain video content.

25. The method of interactive entertainment according to claim 22, where said plurality of entertainment files contains audio and video content.

26. The method of interactive entertainment according to claim 23, where said audio content includes songs.

27. The method of interactive entertainment according to claim 26, where said songs include a plurality of music genres.

28. The method of interactive entertainment according to claim 27, further comprising the step of:
a. categorizing the plurality of music genres.

29. The method of interactive entertainment according to claim 25, where said audio and video content includes televised programming.

30. A method of interactive entertainment comprising the steps of:
a. streaming a plurality of entertainment files over a communications network;
b. retrieving a current play entertainment file from the plurality of entertainment files;
c. retrieving a user rating associated with the current play entertainment file;
d. if the user rating is not equal to a predetermined value, then performing the following steps f-h;
e. if the user rating is equal to a predetermined value, then go to step m:
f. retrieving user ratings associated with other entertainment files within the plurality of entertainment files;
g. comparing the user ratings associated with the other entertainment files with the predetermined value;
h. if any other entertainment files have a rating equal to the predetermined value, designating a selected entertainment file, where the selected entertainment file has a rating equal to the predetermined value;
i. retrieving the selected entertainment file;
j. substituting the selected entertainment file for the current play entertainment file;
k. transmitting the selected entertainment file until complete; and
l. repeating steps a-e until a user executes a termination command.
m. transmitting the current play entertainment file until complete; and
n. repeating steps a-e until a user executes a termination command.

31. The method of interactive entertainment according to claim 30, further comprising the step of:
a. supplying audio content with each of the entertainment files.

32. The method of interactive entertainment according to claim 30, further comprising the step of:
a. supplying audio and video content with each of the entertainment files.

33. The method of interactive entertainment according to claim 30, further comprising the step of:
a. supplying video content with each of the entertainment files.

34. The method of interactive entertainment according to claim 31, where said audio content includes songs.

35. The method of interactive entertainment according to claim 34, where said songs include a plurality of music genres.

36. The method of interactive entertainment according to claim 35, further comprising the step of:
a. categorizing the plurality of music genres.

37. The method of interactive entertainment according to claim 32, where said audio and video content includes televised programming.

38. An entertainment system that enables the selective transfer of entertainment files comprising:
a system server, said system server residing at a communication center;
a system database, said system database residing at the communication center and accessible by the system server;
a plurality of entertainment files stored on the database, where the system server retrieves the plurality of entertainment files for transmission over a first communication network;
a receiver, where the receiver selectively retrieves the plurality of entertainment files via the first communication network from the system server based a user's preferences;
a user input device; and
a user output device, where the user utilizes the input device to initiate the transfer of selected entertainment files to said output device.

39. The method of interactive entertainment according to claim 38, further comprising the step of:
a. supplying audio content with each of the entertainment files.

40. The method of interactive entertainment according to claim 38, further comprising the step of:
a. supplying audio and video content with each of the entertainment files.

41. The method of interactive entertainment according to claim 38, further comprising the step of:
a. supplying video content with each of the entertainment files.

42. A receiver for the reception of entertainment files comprising:
a data input, said data input capable of receiving entertainment files via a first communications network;
a data output, said data output capable of transmitting entertainment files via a second communications network;
a database, said database storing entertainment files received through the data input;
a processor, said processor performing selective filtering based upon instructions provide by software residing on said database, where said instructions include functional instructions related to the data input, data output and data transfer from the database and functional instructions capable of selectively filtering entertainment files received through the data input; and
a user command input, said user command input capable of receiving commands from a user input device.

43. The receiver for the reception of entertainment files according to claim 42, wherein said processor selectively filters the entertainment files based upon a user's preferences.

44. The receiver for the reception of entertainment files according to claim 42 where each entertainment file includes a user rating, said processor determines if the user rating for each entertainment file is equal to a predetermined value, if so then processor enables the continued output of said entertainment file, if not the processor triggers the retrieval of a second entertainment file which is equal to the predetermined value and substitutes the second entertainment file for transmission through the data output.

45. The receiver for the reception of entertainment files according to claim 42, the processor may receive a rejection indication from a user via the user command input, if so the processor associates the rejection indication with the entertainment file and stores the rejection—entertainment file association in the database, then the processor retrieves a subsequent entertainment file for transmission through the data output.

46. The receiver for the reception of entertainment files according to claim 43, wherein the entertainment files include at least one of audio files, video files and audio/video files.

47. The receiver for the reception of entertainment files according to claim 44, wherein the entertainment files include at least one of audio files, video files and audio/video files.

48. The receiver for the reception of entertainment files according to claim 45, wherein the entertainment files include at least one of audio files, video files and audio/video files.

49. A method of transmitting entertainment files through a receiver comprising the steps of:
a. transmitting a plurality of entertainment files to the receiver via a first communications network;
b. receiving the plurality of entertainment files through a data input;
c. storing the plurality of entertainment files in a database residing within the receiver;
d. selectively filtering the output of the entertainment files through a data output, where the selective filtering is based upon filtering instructions with a software residing in the database;
e. executing the filtering instructions via a processor; and
f. receiving user commands via a user command input from a user input device.

50. The method of transmitting entertainment files through a receiver according to claim 49, wherein the plurality of entertainment files includes at least one of audio files, video files and audio/video files.
